(19) United States
(12) Patent Application Publication
(10) Pub. No.: US 2007/0281760 A1
(43) Pub. Date: Dec. 6, 2007

(54) Wireless, batteryless, audio communications device

(75) Inventors: Pavel Nikitin, Seattle, WA (US); Venkata Kodukula, Bothell, WA (US); Rene Martinez, Seattle, WA (US)

Correspondence Address: SEED INTELLECTUAL PROPERTY LAW GROUP PLLC, 701 FIFTH AVENUE, SUITE 5400, SEATTLE, WA, 98104-7092, US

(73) Assignee: Intermec IP Corp., Woodland Hills, CA (US)

(21) Appl. No.: 11/438,903

(22) Filed: May 23, 2006

(51) Int. Cl. H04B 1/16; H04B 1/38; H04M 1/00

(52) U.S. Cl. 455/575.2; 455/572; 455/343.1

(57) ABSTRACT

A wireless, batteryless microphone includes an antenna and passive circuitry to backscatter a carrier wave signal modulated with audio information from a sound transducer. A wireless, batteryless speaker or headphone includes an antenna and passive circuitry to drive a sound transducer based on a received modulated carrier wave. A headset may include a wireless, batteryless microphone and one or more wireless, batteryless speakers or headphones.

### BACKGROUND

1. Field

This disclosure generally relates to audio communications devices for example microphones, speakers, and headsets employing microphones and speakers.

2. Description of the Related Art

Audio communications devices such as microphones and/or speakers are in common usage. Such devices typically employ sound transducers to convert sound energy into electrical signals and/or electrical signals into sound energy. For example, microphones typically transform sound energy into electrical signals, while speakers typically transform electrical signals into sound energy. Audio communications devices may be used in a large variety of circumstance. For example, by performers in live or recorded performances, by call center personnel, by coaches, by pilots or air traffic controllers, by military or first responders, or even in everyday mobile communications.

Audio communications devices typically employ a hardwired connection to receive power, or alternatively rely on one or more batteries. Hardwired connections disadvantageously reduce the mobility of audio communications devices. Audio communications devices that employ batteries are limited in duration of use, are typically heavy, and have a large form factor. Such disadvantageously reduces the portability of these devices. For example, batteries are not easily accommodated in small light weight headphones or headsets, and contribute significantly to fatigue of the wearer.

A number of batteryless technologies have been applied to audio communications. An approach taught in U.S. Pat. No. 836,531, employs a piezoelectric element or crystal in the classic crystal radio to receive electrical signals and produce sound from a speaker. Such an approach typically requires an earth ground for the wave interceptor antenna. An approach taught in U.S. Pat. No. 837,616, employs a thermo-junction to receive electrical signals and produce sound from a speaker. Neither of these approaches appear to be commercially successful, and neither approach appears to the problem of converting sound to electrical signals.

An improved wireless, batteryless approach to providing audio communications would be desirable.

### BRIEF SUMMARY

In one embodiment, a wireless, batteryless, audio communications device is shown, the device comprising a first sound transducer, the first sound transducer operable to convert sound energy into electrical energy in the form of electrical signals, at least a first antenna, and a first passive circuit operatively coupled to the first sound transducer and to the first antenna to modulate at least some carrier waves received via the first antenna based on the electrical signals from the sound transducer, and to cause the audio communications device to backscatter the modulated carrier waves.

In another embodiment, a wireless, batteryless, audio communications device is shown, the device comprising antenna means for receiving carrier waves, transducer means for producing electrical signals in response to sound, and passive circuit means for modulating at least some of the received carrier waves with electrical signals from the first transducer means, and backscattering the modulated carrier waves from the audio communications device.

In yet another embodiment, a method of operating a wireless, batteryless, audio communications device is described, the method comprising receiving carrier waves at a first antenna, modulating at least some of the received carrier waves at a first passive circuit with audio signals from a first sound transducer, and backscattering the modulated carrier waves from the audio communications device.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram showing a wireless, batteryless microphone in wireless communications with a transmitter/receiver unit, according to one illustrated embodiment.

FIG. 2 is a schematic diagram of a wireless, batteryless speaker in wireless communications with a transmitter according to one illustrated embodiment.

FIG. 3 is a schematic diagram of a wireless, batteryless headset employing a common antenna for wirelessly communicating with a transceiver according to one illustrated embodiment.

FIG. 4 is a functional block diagram of the wireless, batteryless headset of FIG. 3, according to one illustrated embodiment.

FIG. 5 is a schematic diagram illustrating a transformation of audio information to wireless information, back to audio information for a speaker, and transformation of audio information from a microphone into wireless information and back into audio information, according to one illustrated embodiment.

FIG. 6 is a schematic diagram of a wireless, batteryless headset employing separate antennas for the wireless, batteryless speaker and the wireless, batteryless microphone, respectively, according to one illustrated embodiment.

FIG. 7 is a schematic diagram of a wireless, batteryless headset employing separate receiving and backscatter antennas for the wireless, batteryless speaker, as well as separate receiving and backscatter antennas for the wireless, batteryless microphone, according to another illustrated embodiment.

FIG. 8 is an isometric view of a headset worn by a person, according to one illustrated embodiment.

FIG. 9 is a flow diagram of a method of operating a wireless, batteryless microphone according to one illustrated embodiment.

FIG. 10 is a flow diagram of a method of operating a wireless, batteryless speaker according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with transmitters, receivers, transceivers, and sound transducers have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

The headings provided herein are for convenience only and do not interpret the scope or meaning of the embodiments.

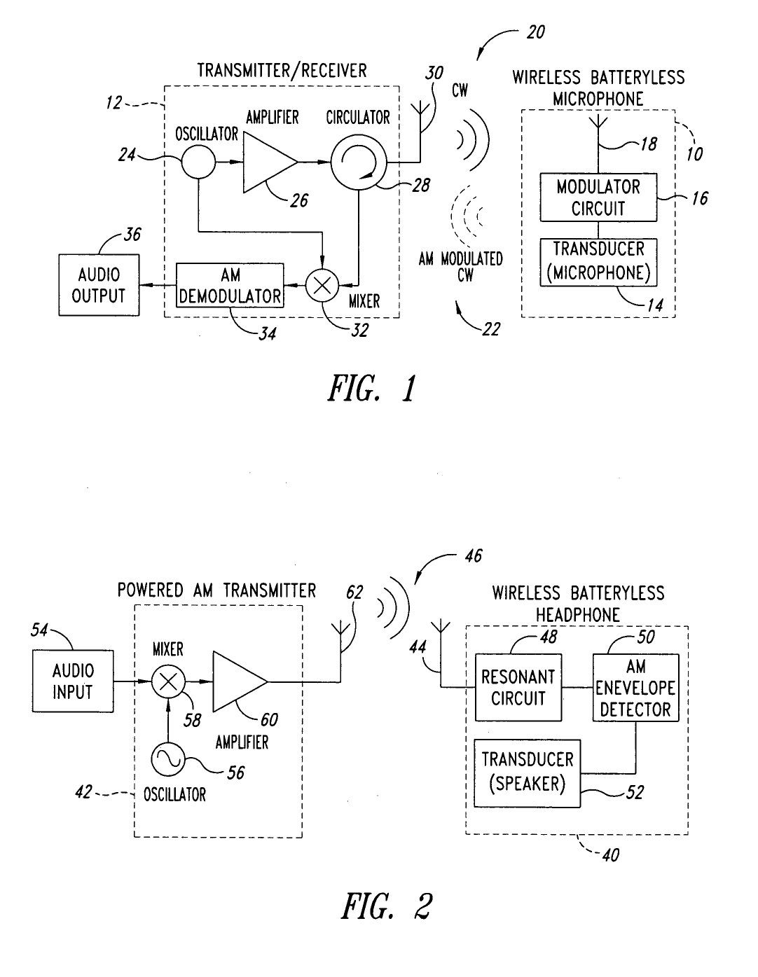

FIG. 1 shows a wireless, batteryless microphone 10 wirelessly communicating with a transmitter/receiver or transceiver 12 according to one illustrated embodiment.

The wireless, batteryless microphone 10 includes a sound transducer 14 operable to convert sound energy into electrical signals. The wireless, batteryless microphone 10 also includes a modulator circuit 16 and an antenna 18. The modulator circuit 16 is operable to modulate a carrier wave 20 received by the antenna 18 and to backscatter a modulated carrier wave 22 based on the electrical signals from the transducer 14.

The transceiver 12 includes an oscillator 24, amplifier 26, circulator 28 and antenna 30, coupled to produce the carrier wave 20. The antenna 30 and circulator 28 receive the modulated carrier wave 22 and provide the modulated carrier wave 22 to a mixer 32. The mixer 32 also receives the oscillation signal from the oscillator 24, and provides the resulting mixed signal to a demodulator 34. The demodulator 34 provides audio output 36. The audio output 36 may be recorded, or may be used to drive a speaker (not shown).

The carrier wave 20 may take the form of a constant wavelength signal, and may, for example, operate in the UHF ISM band (e.g., 902-928 MHz). As illustrated in the link budget table (TABLE A), the above described embodiment of the wireless, batteryless microphone 10 may operate at range of approximately 50 feet, even where a typical receiver may have an average sensitivity of −60 dBm or better.

TABLE A

| | | |
|---|---|---|
| Transmitted CW EIRP | 36 | dBm (4 W) |
| Free Space Path Loss from Transceiver | −47 | dB |
| to Microphone 50 feet away at 915 MHZ | | |
| Microphone Matching Loss | −3 | dB |
| Transceiver Antenna Gain | 3 | dBi |
| Backscattered Power | −11 | dBm |
| Free Space Path Loss from Microphone | −47 | dBm |
| to Transceiver 50 feet away at 915 MHZ | | |
| Power at Receiver | −58 | dBm |
| Power Required (Receiver Sensitivity | −60 | dBm |

FIG. 2 shows a wireless, batteryless speaker or headphone 40 wirelessly communicating with a transmitter 42 according to one illustrated embodiment.

The wireless, batteryless headphone 40 includes an antenna 44 that receives a modulated carrier wave 46 from the transmitter 42. The antenna 44 is coupled to a resonant circuit 48 which provides a received signal to an envelope detector 50. The envelope detector 50 produces electric signals, which are coupled to drive a sound transducer 52, for example, as a speaker.

The transmitter 42 may include an audio input 54, oscillator 56, mixer 58, amplifier 60, and antenna 62. The audio input 54 provides audio signals to the mixer 58 from some signal source. The oscillator 56 provides an oscillation signal to the mixer 58. The mixer 58 mixes the audio and oscillation signals and provide the mixed signal to the amplifier 60. The amplifier 60 amplifies the output of mixer 58, and broadcasts the amplified output via the antenna 62.

The carrier wave 20 may take the form of a constant wavelength signal, and may, for example, operate in the UHF ISM band (e.g., 902-928 MHz). As illustrated in the link budget table (TABLE B), the above described embodiment of the wireless, batteryless headphone 40 may operate at range of approximately 4 feet, where typical high impedance headphones may have a sensitivity of 1 mW or better (require approximately 1 mW of power or less to produce a clear audible signal).

TABLE B

| | | |
|---|---|---|
| Transmitted EIRP | 36 | dBm (4 W) |
| Free Space Path Loss from Transmitter to | −33 | dB |
| Headphone 4 feet away at 915 MHZ | | |
| Receiving Antenna Gain | 2 | dBi |
| Matching Loss/Detector Efficiency | −3 | dBi |
| Power at Headphone | 2 | dBm (1.6 mW) |
| Power Required (Headphone Sensitivity) | 0 | dBm (1 mW) |

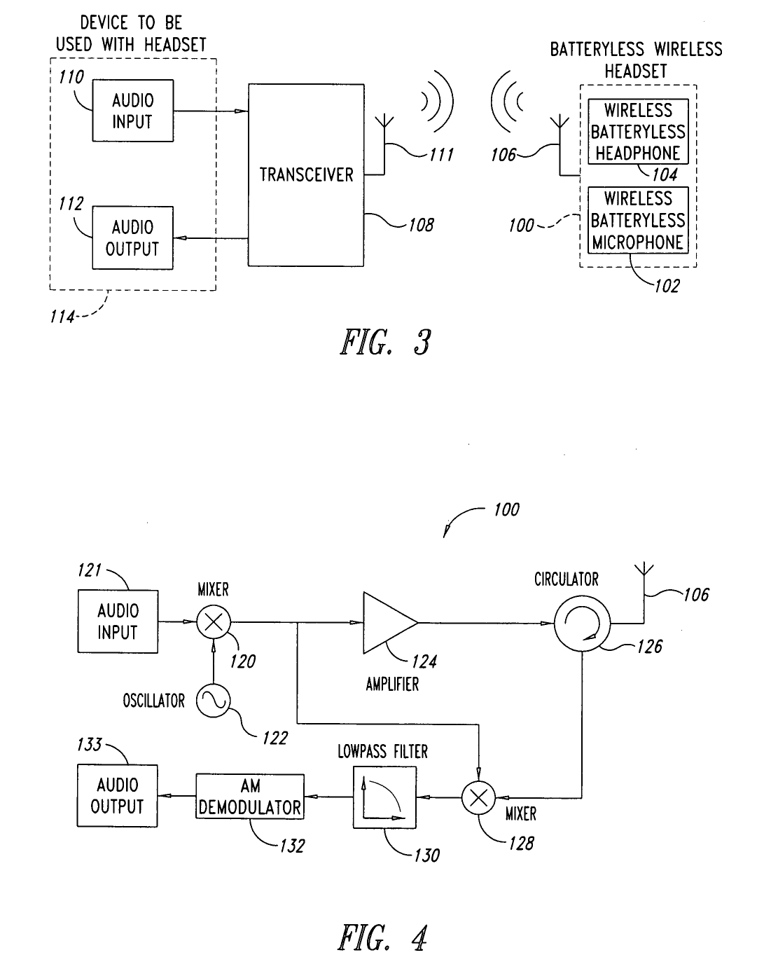

FIG. 3 shows a wireless, batteryless headset 100 according to one illustrated embodiment.

The headset 100 may include a wireless, batteryless microphone 102, a wireless, batteryless speaker or headphone 104, and a common antenna 106. The wireless, batteryless microphone 102 may take a form similar to that shown in FIG. 1. The wireless, batteryless headphone 104 may take a form similar to that shown in FIG. 2.

The headset 100 wirelessly communicates with a transceiver 108. The transceiver 108 receives audio input 110 from, and provides audio output 112 to, a device 114 to be used with the headset 100.

The range of duplex operation of the headset 100 would be limited by the range of the wireless, batteryless speaker or headphone 104. Both the wireless, batteryless microphone 102 and the a wireless, batteryless speaker or headphone 104 may be optimized and their ranges significantly improved, for example, by using resistive sound transducers as the microphone, a bridge diode detector, and/or high impedance headphone.

The microphone 102 and the headphone 104 may be totally passive devices, the transceiver 108 handling all of the “intelligence” and active RF transmission burden. The microphone 102 and the headphone 104 may operate at the same carrier frequency. In such a case, the interrogation of the microphone 102 may be performed using an amplitude modulated (AM) signal which is then modulated again by the microphone 102 and backscattered to the transceiver 108. Thus, a carrier wave signal is modulated twice, first by the audio signal for the headphone 104, and then by the audio signal from the microphone 102. Since the transceiver 108 knows the AM signal that was sent, the transceiver is able to extract the audio signal generated by the microphone 102 from the received modulated backscattered carrier wave.

FIG. 4 is a functional block diagram of the wireless, batteryless headset 100, according to one illustrated embodiment.

The wireless, batteryless headset 100 includes a mixer 120 that receives audio signals from an audio input 121. The mixer also includes an oscillator 122 that provides oscillation signals to the mixer 120. The mixer 120 provides a mixed signal to an amplifier 124. The amplifier amplifies the mixed signals and supplies the amplified mixed signal to a circulator 126. The circulator is coupled to drive the antenna 106.

The antenna 106 also receives signals. The circulator 126 provides the signals received by the antenna 106 to a second mixer 128. The second mixer 128 also receives the mixed signal from the first mixer 120. A low pass filter 130 low pass filters the output from the second mixer 128. A demodulator 132 demodulates the output of the low pass filter 130 to provide a signal to an audio output 133.

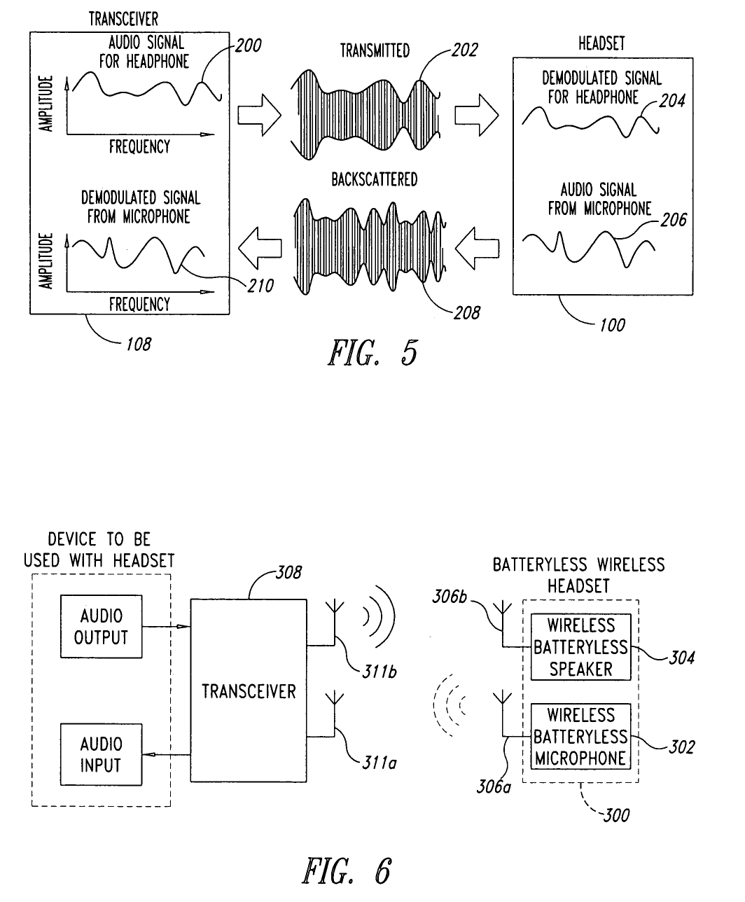

FIG. 5 illustrates the conversion between audio signals and carrier waves according to one illustrated embodiment.

The transceiver 108 operates to transmit an audio signal 200 to the headset 100 as a transmitted carrier wave 202. The headset 100 operates to convert the received carrier wave 200 into a demodulated audio signal 204. The demodulated audio signal 204 may be used to drive a sound transducer, as a headphone or speaker.

The headset 100 operates to transmit an audio signal 206 to the transceiver 108 as a backscatter modulated carrier wave 208. The audio signal 206 may be produced by a sound transducer operating as a microphone. The transceiver 108 demodulates the received backscattered modulated carrier wave 208 into a demodulated audio signal 210. The demodulated audio signal 210 may be recorded or used to drive a sound transducer as a speaker.

FIG. 6 shows a wireless, batteryless headset 300 and transceiver 308, according to another embodiment.

The wireless, batteryless headset 300 includes a wireless, batteryless microphone 302 and wireless, batteryless headphone 104 similar to that of FIG. 3. The wireless, batteryless headset 300 includes a first antenna 306a and a second antenna 306b. The first antenna 306a is coupled to the wireless, batteryless microphone 302 for receiving carrier waves and transmitting modulated carrier waves. The respective antenna 306b is coupled to the wireless, batteryless speaker 304 for receiving modulated carrier waves.

The transceiver 308 may include a first antenna 311 a and a second antenna 311b, for wirelessly communicating with the first antenna 306a and second antenna 306b, respectively, of the wireless, batteryless headset 300. This approach may facilitate wireless communications by allowing the use of different carrier frequencies for the up and down channels. Such may, for example, prevent or reduce interference between the channels.

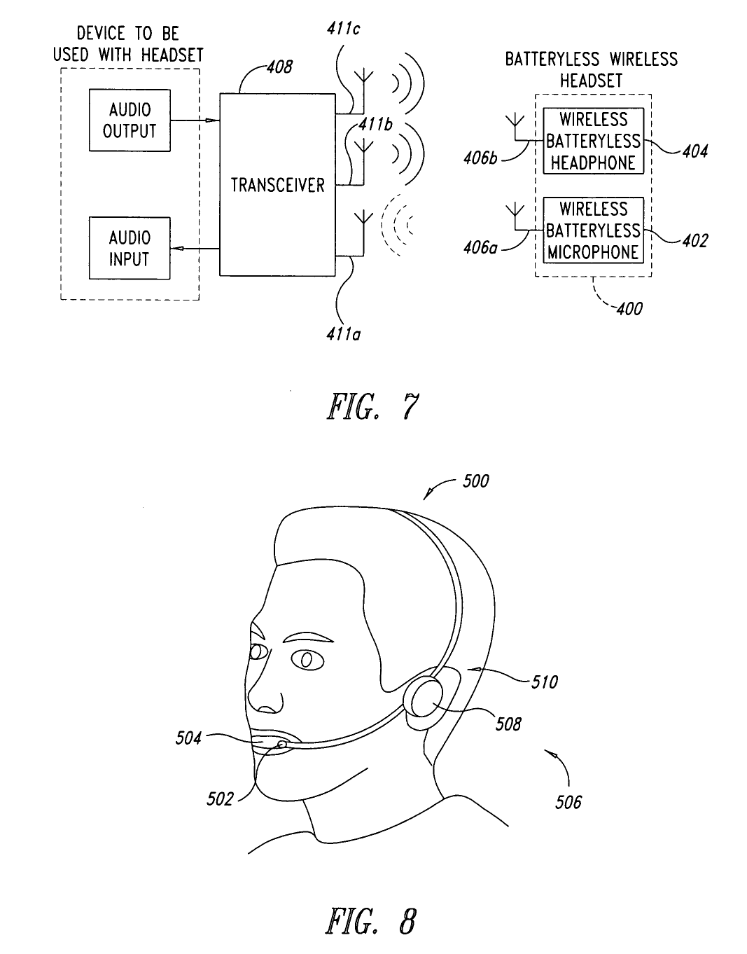

FIG. 7 shows a wireless, batteryless headset 400 and transceiver 308, according to a further embodiment.

The wireless, batteryless headset 400 includes a wireless, batteryless microphone 402 and a wireless, batteryless speaker 404 The wireless, batteryless microphone 402 is coupled to a first antenna 406a to receive a carrier wave for backscattering a modulated carrier wave. The wireless, batteryless speaker or headphone 404 includes a second antenna 406b to receive the modulated carrier wave.

The wireless, batteryless microphone 402 may employ energy from the received carrier wave to power the microphone 402. The wireless, batteryless microphone 402 may modulate and backscatter the carrier wave based on electrical signal produced by the microphone 402. The wireless, batteryless speaker 404 may demodulate the modulated carrier wave to produce audio signals for driving the speaker 404.

The transceiver 408 may include respective antennas 411a-411c for wirelessly communicating with the antennas 406a-406b.

FIG. 8 shows a headset 500 including a microphone 502 positioned proximate a mouth 504 of a head 506. The headset 500 also includes one or more speakers or headphones 508 positioned proximate to one or more ears 510 of the head 506.

The modulator circuits and antennas of the various previously described embodiments may be identical or similar to those taught in U.S. Pat. Nos. 5,942,987 and 6,078,259, or other patents, patent publications or non-patent publications directed to the field of radio frequency identification (RFID). Typically, passive backscattered RFID systems employ a base station or reader that transmits a modulated signal with periods of un-modulated carrier, which is received the antenna of the RFID tag or circuit. An RF voltage developed on the antenna terminals during the un-modulated period is converted to a direct current (DC) which powers the RFID tag or circuit. The RFID tag or circuit transmits back information by varying a front end complex RF input impedance. The impedance typically toggles between two different states, between conjugate match and some other impedance, effectively modulating the backscattered signal. As explained herein, the wireless, batteryless microphone and/or speaker may employ a similar or identical approach.

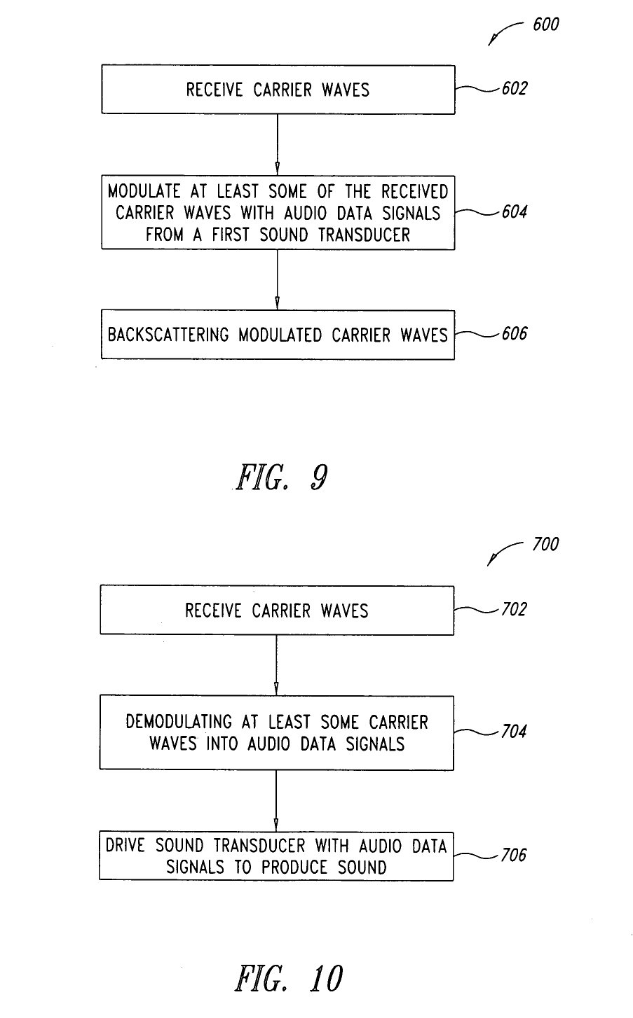

FIG. 9 shows a method 600 of operating a wireless, batteryless microphone 10, 102, 302, 402, 502, according to one illustrated embodiment.

At 602, the wireless, batteryless microphone 10, 102, 302, 402, 502 receives carrier waves. At 604, the wireless, batteryless microphone 10, 102, 302, 402, 502 modulates at least some of the received carrier waves with audio signals from a first sound transducer. At 606, the wireless, batteryless microphone 10, 102, 302, 402, 502 backscatters the modulated carrier waves.

FIG. 10 shows a method 700 of operating a wireless, batteryless speaker or headphone 40, 104, 304, 404, 508, according to one illustrated embodiment.

At 702, the wireless, batteryless headphone 40, 104, 304, 404, 508 receives carrier waves. At 704, the wireless, batteryless headphone 40, 104, 304, 404, 508 demodulates at least some of the carrier waves into electrical signals. At 706, the wireless, batteryless headphone 40, 104, 304, 404, 508 drives a sound transducer with the electrical signals to produce sound.

The above description of illustrated embodiments, including what is described in the Abstract, is not intended to be exhaustive or to limit the invention to the precise forms disclosed. Although specific embodiments of and examples are described herein for illustrative purposes, various equivalent modifications can be made without departing from the spirit and scope of the invention, as will be recognized by those skilled in the relevant art.

The teachings provided herein of the can be applied to other sound transducers, not necessarily the exemplary headset, microphone and/or headphones generally described above. For example, the teachings may be employed with cassette, compact disc (CD), MP3 or other audio players. The teachings may be employed with DVD players, televisions, and/or computers. The teachings may be employed to provide wireless, batteryless microphones for presentations, concerts, or lectures. The teachings may be employed to provide wireless, batteryless speakers or headphones for cellular, satellite or terrestrial telephones, computer gaming or any other one- or two-way communications devices.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via discrete electronic circuit components. In another embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including but not limited to commonly assigned U.S. Pat. Nos. 5,942,987 and 6,078,259, are incorporated herein by reference, in their entirety. Aspects of the embodiments can be modified, if necessary, to employ systems, circuits and concepts of the various patents, applications and publications to provide yet further embodiments.

These and other changes can be made in light of the above-detailed description. In general, in the following claims, the terms used should not be construed to limit the claims to the specific embodiments disclosed in the specification and the claims, but should be construed to include all sound transducer devices that operated in accordance with the claims. Accordingly, the claims are not limited by the disclosure.

We/I claim:

1. A wireless, batteryless, audio communications device, comprising:
a first sound transducer, the first sound transducer operable to convert sound energy into electrical energy in the form of electrical signals;
at least a first antenna; and
a first passive circuit operatively coupled to the first sound transducer and to the first antenna to modulate at least some carrier waves received via the first antenna based on the electrical signals from the sound transducer, and to cause the audio communications device to backscatter the modulated carrier waves.

2. The wireless, batteryless, audio communications device of claim 1, wherein first passive circuit is coupled to backscatter the modulated carrier waves via the first antenna.

3. The wireless, batteryless, audio communications device of claim 1, further comprising:
a second antenna, wherein first passive circuit is coupled to backscatter the modulated carrier waves via the second antenna.

4. The wireless, batteryless, audio communications device of claim 1, further comprising:
at least a second sound transducer, the second sound transducer operable to convert electrical energy in the form of electrical signals into sound energy.

5. The wireless, batteryless, audio communications device of claim 1, further comprising:
at least a second sound transducer, the second sound transducer operable to convert electrical energy in the form of electrical signals into sound energy, wherein the first passive circuit is further operatively coupled to demodulate at least some carrier waves received by the audio communications device into electrical signals to drive the second sound transducer.

6. The wireless, batteryless, audio communications device of claim 5 wherein the first passive circuit is coupled to the first antenna to receive the at least some carrier waves that the first passive circuit is operatively coupled to demodulate.

7. The wireless, batteryless, audio communications device of claim 5, further comprising:
a second antenna, wherein the first passive circuit is coupled to the second antenna to receive the at least some carrier waves that the first passive circuit is operatively coupled to demodulate.

8. The wireless, batteryless, audio communications device of claim 1, further comprising:
at least a second sound transducer, the second sound transducer operable to convert electrical energy in the form of electrical signals into sound energy; and
a second passive circuit operatively coupled to demodulate at least some carrier waves received by the audio communications device into electrical signals to drive the second sound transducer.

9. The wireless, batteryless, audio communications device of claim 8 wherein the second passive circuit is coupled to the first antenna to receive the at least some carrier waves that the second passive circuit is operatively coupled to demodulate.

10. The wireless, batteryless, audio communications device of claim 8, further comprising:
a second antenna, wherein the second passive circuit is coupled to the second antenna to receive the at least some carrier waves that the second passive circuit is operatively coupled to demodulate.

11. The wireless, batteryless, audio communications device of claim 1, further comprising:
a head piece, the first sound transducer coupled to the head piece proximate a position where a mouth would be when the head piece is worn on a human head, and the second sound transducer coupled to the head piece proximate to a position where a first ear would be when the head piece is worn on the human head.

12. The wireless, batteryless, audio communications device of claim 11, further comprising:
a third sound transducer, the second sound transducer operable to convert electrical energy in the form of electrical signals into sound energy, the third sound transducer coupled to the head piece proximate to a position where a second ear would be when the head piece is worn on the human head.

13. The wireless, batteryless, audio communications device of claim 11 wherein the first antenna and first passive circuit are tuned to a carrier wave frequency (e.g., in UHF ISM band between approximately 902 MHz and 928 MHz).

14. A wireless, batteryless, audio communications device, comprising:
antenna means for receiving carrier waves;
transducer means for producing electrical signals in response to sound; and
passive circuit means for modulating at least some of the received carrier waves with electrical signals from the first transducer means, and backscattering the modulated carrier waves from the audio communications device.

15. The wireless, batteryless, audio communications device of claim 14, further comprising:
passive circuit means for demodulating at least some of the received carrier waves to produce electrical signals.

16. The wireless, batteryless, audio communications device of claim 15, further comprising:
transducer means for producing sound in response to the electrical signals from the passive circuit means.

17. The wireless, batteryless, audio communications device of claim 14 wherein the passive circuit means derives power from the carrier waves without the use of a crystal element, a piezoelectric element or a thermo-junction element.

18. A method of operating a wireless, batteryless, audio communications device, the method comprising:
receiving carrier waves at a first antenna;
modulating at least some of the received carrier waves at a first passive circuit with audio signals from a first sound transducer; and
backscattering the modulated carrier waves from the audio communications device.

19. The method of claim 18 wherein backscattering the modulated carrier waves from the audio communications device comprises backscattering the modulated carrier waves via the first antenna.

20. The method of claim 18, further comprising:
demodulating at least some carrier waves received by the audio communications device into electrical signals; and
driving a second sound transducer with the electrical signals from the demodulation of the at least some carrier waves to produce sound.

21. The method of claim 20, further comprising:
receiving the at least some carrier waves which are to be demodulated at the first antenna.

22. The method of claim 20, further comprising:
receiving the at least some carrier waves that are to be demodulated at a second antenna.

23. The method of claim 18 wherein demodulating at least some carrier waves received by the audio communications device into electrical signals comprises demodulating the at least some carrier waves with the first passive circuit.

24. The method of claim 18 wherein demodulating at least some carrier waves received by the audio communications device into electrical signals comprises demodulating the at least some carrier waves with a second first passive circuit.

25. The method of claim 18 wherein receiving carrier waves at a first antenna comprises receiving carrier waves at some frequency between approximately 902 MHz and approximately 928 MHz.
